(19) United States
(12) Patent Application Publication
(10) Pub. No.: US 2023/0357079 A1
(43) Pub. Date: Nov. 9, 2023

(54) ELEVATOR ELEMENT, MANUFACTURING METHOD THEREOF AND ELEVATOR

(71) Applicant: KONE Corporation, Helsinki (FI)

(72) Inventor: Tapani TALONEN, HELSINKI (FI)

(73) Assignee: KONE Corporation, Helsinki (FI)

(21) Appl. No.: 18/222,795

(22) Filed: Jul. 17, 2023

Related U.S. Application Data
(63) Continuation of application No. PCT/FI2021/050079, filed on Feb. 4, 2021.

(51) Int. Cl. C04B 7/153; C04B 28/00; C04B 7/19; C04B 28/04

(52) U.S. Cl. CPC C04B 7/1535; C04B 28/006; C04B 7/19; C04B 28/04

(57) ABSTRACT

An elevator element manufacturing method, an elevator element and an elevator are disclosed. The manufacturing method includes providing material including aluminium silicate precursor and/or calcium silicate precursor in powder and/or granulate form, filling a mould with a mixture including the material, alkalic reactance, and water for creating a mixture, and allowing the mixture to realize a polycondensation reaction in the mould for forming a polymer structure based on polycondensation bonding structures.

### BACKGROUND

The invention relates to a method for manufacturing an elevator element.

The invention further relates to an elevator element.

The invention still further relates to an elevator.

A challenge with manufacturing of elevators is that environmental load thereof shall be cut down.

### BRIEF DESCRIPTION

Viewed from a first aspect, there can be provided an elevator element manufacturing method, comprising
providing material comprising aluminium silicate precursor and/or calcium silicate precursor in powder and/or granulate form,
filling a mould with a mixture comprising said material, alkalic reactance, and water for creating a mixture,
allowing the mixture to realize a polycondensation reaction in the mould for
forming a polymer structure based on polycondensation bonding structures.

Thereby the environmental load caused by manufacturing of elevators may be reduced. Additionally, mechanically strong and resilient and chemically resistant elevator elements may be manufactured so that there is no need for structural reinforcements by e.g. steel or fibre reinforcements.

Viewed from a further aspect, there can be provided an elevator element comprising a body part manufactured by the method as described above.

Thereby elevator elements having a low environmental load may be achieved. Additionally, mechanically strong and resilient and chemically resistant elevator elements may be manufactured so that there is no need for structural reinforcements by e.g. steel or fibre reinforcements.

Viewed from a still further aspect, there can be provided an elevator comprising an elevator shaft, an elevator car arranged in the elevator shaft, and an elevator element manufactured by the method mentioned above.

Thereby an elevator the manufacturing of which is less polluting may be achieved.

The method, the element and the elevator are characterised by what is stated in the independent claims. Some other embodiments are characterised by what is stated in the other claims. Inventive embodiments are also disclosed in the specification and drawings of this patent application. The inventive content of the patent application may also be defined in other ways than defined in the following claims. The inventive content may also be formed of several separate inventions, especially if the invention is examined in the light of expressed or implicit sub-tasks or in view of obtained benefits or benefit groups. Some of the definitions contained in the following claims may then be unnecessary in view of the separate inventive ideas. Features of the different embodiments of the invention may, within the scope of the basic inventive idea, be applied to other embodiments.

In one embodiment, the aluminosilicate precursor material comprises at least one of:
blast furnace slag (BF slag),
basic-oxygen furnace slag (BOF slag),
electric-arc furnace slag (EAF slag),
klockner oxygen blown maxhutte slag (KOBM slag), and
casting slag.

An advantage is that the material is amply available. Furthermore, especially BOF and KOBM are highly reactive in the polycondensation reaction, resulting thus a strong structure of the manufactured element.

In one embodiment, the aluminosilicate precursor material comprises rock-based geopolymer cement. An advantage is that the material is amply available.

In one embodiment, the aluminosilicate precursor material comprises fly ash-based geopolymer cement. An advantage is that the material is amply available.

In one embodiment, the aluminosilicate precursor material comprises ferro-sialate-based geopolymer cement. An advantage is that the material is amply available.

In one embodiment, a filler material, such as metal-based granulates, is added in the mixture for increasing density of the elevator element. An advantage is that the weight of the elevator element can be increased without increasing its volume, and thus e.g. a compact counterweight or balance weight is achievable.

In one embodiment, the elevator element is moulded in ambient pressure. An advantage is that an energy-saving process may be achieved.

In one embodiment, the elevator element is compression moulded. An advantage is that complicated shapes of the element may be manufactured.

In one embodiment, the elevator element is a filler-bit of a counterweight or a balance weight. An advantage is that due to a mechanically and chemically strong structure of the material, there is no need for e.g. steel or fibre reinforcement and thus a simple manufacture and structure of the weight may be achieved.

In one embodiment, the elevator element is a car ballast arranged in an elevator car. An advantage is that due to a mechanically and chemically strong structure of the material, there is no need for e.g. steel or fibre reinforcement and thus a simple manufacture and structure of the ballast may be achieved.

### BRIEF DESCRIPTION OF FIGURES

Some embodiments illustrating the present disclosure are described in more detail in the attached drawings, in which

FIG. 1 is a schematic view of an elevator element,

FIG. 2 is a schematic view of an elevator counterweight,

FIG. 3 is a schematic view of an elevator, and

FIG. 4 is a schematic illustration of an elevator element manufacturing method.

In the figures, some embodiments are shown simplified for the sake of clarity. Similar parts are marked with the same reference numbers in the figures.

### DETAILED DESCRIPTION

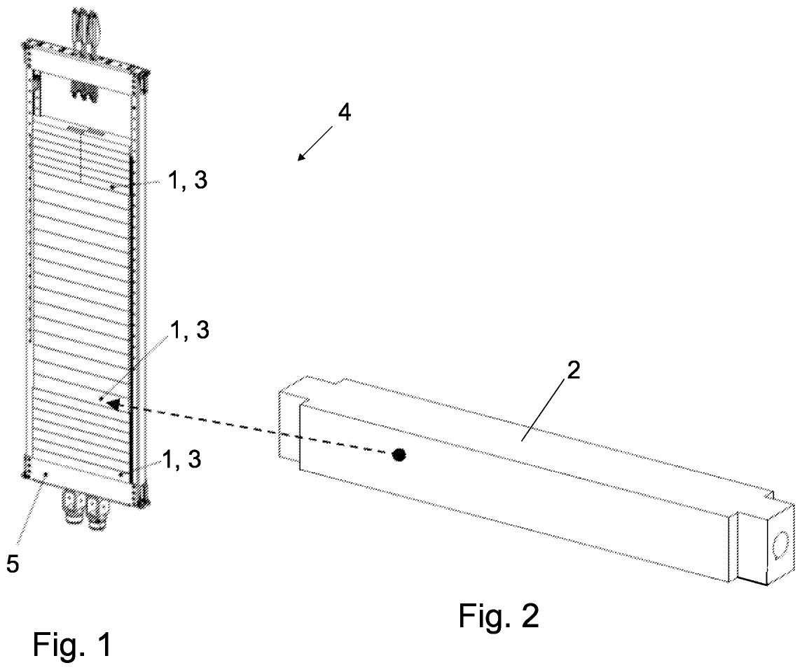

FIG. 1 is a schematic view of an elevator element, and FIG. 2 is a schematic view of an elevator counterweight.

The method according to the current disclosure is used for manufacturing elevator elements. In one embodiment, the elevator element 1 comprises a body part 2 that may constitute a major or a minor part of said elevator element.

In one embodiment, the elevator element 1 is a filler-bit 3 of a weight used in elevators. Said weight may be e.g. a counterweight or a balance weight. Typically, the filler-bit 3 is arranged in a weight assembly 4 that comprises a weight frame 5. The weight frame 5 may receive plurality of filler-bits 3, at least one of which is manufactured by the method according to the current disclosure.

It is to be noted that the shape, number, position etc. of the filler-bit(s) may vary from that shown in Figures. It is also to be noted that the elevator element manufactured by the method according to the current disclosure is not necessary a filler-bit.

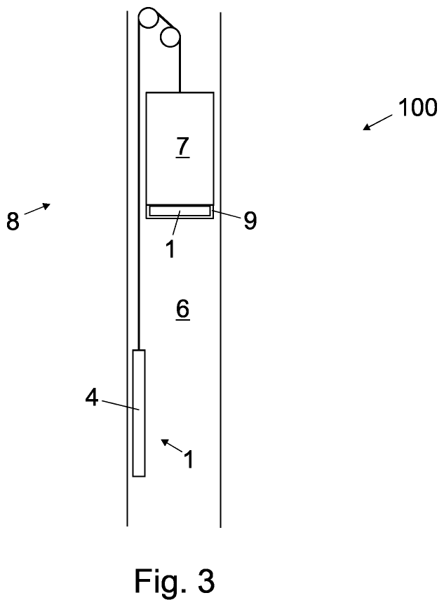

FIG. 3 is a schematic view of an embodiment of an elevator. It is to be noted that the embodiment is shown in a highly simplified manner.

In one embodiment, the elevator 100 comprises an elevator car 7 that defines an interior space for accommodating passengers and/or load. The elevator car 7 is arranged in an elevator shaft 6. The elevator 100 may further comprise a counterweight comprising a weight assembly 4, and a roping 8 arranged to connect the elevator car 7 to the counterweight.

As described already, the element 1 that is manufactured according to this disclosure may be arranged in the weight assembly 4. In one embodiment, at least one element 1 is arranged in the elevator car 7. Said element may serve e.g. as a car ballast. In one embodiment, the car ballast(s) is/are arranged in a holder or rack 9 that is positioned e.g. underside of the elevator car 7.

In one embodiment, the elevator 100 comprises a compensation rope and a tension weight arranged thereto. Said tension weight may comprise the element 1 manufactured according to this disclosure.

In one embodiment, the elevator 100 comprises an overspeed governor rope and a tension weight arranged thereto. Said tension weight may comprise the element 1 manufactured according to this disclosure.

In one embodiment, the elevator 100 comprises a rescue rope and a tension weight arranged thereto. Said tension weight may comprise the element 1 manufactured according to this disclosure.

In one embodiment, the elevator 100 comprises a stalling detection rope and a tension weight arranged thereto. Said tension weight may comprise the element 1 manufactured according to this disclosure.

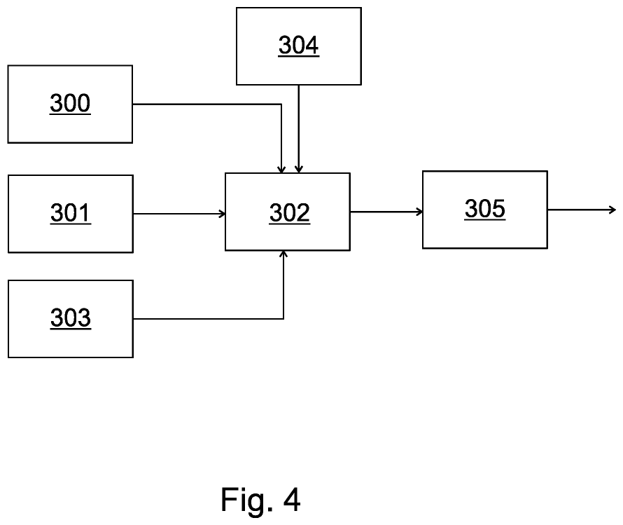

FIG. 4 is a schematic illustration of an elevator element manufacturing method.

In the method there is provided 300 material in powder and/or granulate form, said material comprising aluminium silicate precursor and/or calcium silicate precursor. The material may comprise e.g. ash, fly ash, slag, a silicate comprising mineral, tailings, a side stream material from industrial process, and any mixtures and combinations thereof.

The material may be comminuted into desired size or size distribution, for example close to size of cement powder. For example, it may be comminuted by at least one of grinding, milling, crushing, or cutting.

The ash may be ash obtainable from the combustion or incineration of coal, biomass and/or waste.

The fly ash may be obtainable from the combustion of coal, biomass, oil and/or waste.

The slag may be slag obtainable as a by-product of iron or steel-making.

In one embodiment, the slag comprises blast furnace slag (BF slag). BF slag is a non-metallic coproduct produced in a blast furnace in the production of iron. Typically, BF slag consists primarily of silicates, aluminosilicates, and calcium-alumina-silicates.

In one embodiment, the slag comprises basic-oxygen furnace slag (BOF slag). BOF slag is a waste product in a basic-oxygen furnace generated during the steelmaking process. Typically, BOF slag contains SiO₂, CaO, MgO, iron (mixed oxides), Al₂O₃, MnO, and other oxides.

In one embodiment, the slag comprises electric-arc furnace slag (EAF slag). EAF slag is a non-metallic by-product that consists mainly of silicates and oxides formed during the process of refining the molten steel. Typically, the main elements in the EAF slag are iron, calcium, silicon, and aluminium oxides; the minor elements in the EAF slag are magnesium and manganese oxides.

In one embodiment, the slag comprises klockner oxygen blown maxhutte slag (KOBM slag).

In one embodiment, the slag comprises casting slag that is a waste product generated during the casting of iron or steel.

In one embodiment, the material is a mixture comprising at least two materials mentioned in the current disclosure.

In one embodiment, the material is a mixture comprising at least one material mentioned in the current disclosure and Portland cement.

In the method, water 301 and alkalic reactance 303 are added to the material for creating a mixture suitable for preparing a hardenable mixture or mass that is suitable for casting, and a mould is filled 302 with said mixture.

In one embodiment, a filler material is added 304 in the mixture so that density of the elevator element 100 may be increased. The filler material may comprise e.g. metal-based granulates, such as iron sand or iron granulate, or stone-based particles or sand.

The creating of the hardenable mixture or mass may comprise a step where the mixture is mixed thoroughly. In other words, the mixture is prepared prior to filling the mould.

In another embodiment of the method, water, or at least part thereof, is provided in the mould, and then the material comprising aluminium silicate precursor and/or calcium silicate precursor, such as slag, is added in the mould where is already water. Thus, the mixture is prepared in the mould. The preparing of the mixture in the mould may comprise a step where the mixture is mixed thoroughly.

In still another embodiment of the method, the material comprising aluminium silicate precursor and/or calcium silicate precursor, such as slag, or at least part thereof, is provided in the mould, and then water is added in the mould where is already said material. Thus, the mixture is prepared in the mould. The preparing of the mixture in the mould may comprise a step where the mixture is mixed thoroughly.

In one embodiment, the mould is an open-type of mould wherein the mixture is not compressed or compacted. In another embodiment, the mould is a compression mould wherein the mixture is compressed and compacted during moulding.

In one embodiment, the polycondensation reaction takes place at a room temperature, or at a not-elevated temperature.

Then, the mixture is allowed 305 to realize a polycondensation reaction for forming a polymer structure based on polycondensation bonding structures, and thus harden in the mould.

In one embodiment, the alkalic reactance comprises potassium soluble silicate. In one embodiment, molar ratio MR of said potassium soluble silicate is SiO₂:M₂O≥1.65.

In one embodiment, the alkalic reactance comprises sodium soluble silicate. In one embodiment, molar ratio MR of said sodium soluble silicate is SiO₂:K₂O≥1.65.

As used herein, the term “bonding structure” refers to a chemical unit comprising several atoms bonded together by covalent bonds, ionic bonds, as complexes, crystal structures, or combinations or hybrids thereof. A non-limiting example of bonding structures are tetrahedral arrangements formed by a tetravalent metal covalently bonded to four oxygen atoms. In the aforementioned non-limiting example, several tetrahedral bonding structures may be joined together by covalent bonds to form more complex structures such as double tetrahedrons, triple tetrahedrons, etc. The bonding structure may also incorporate addition ion donators, such as metallic ions, to enable forming the tetrahedral structure with central atoms that are divalent or trivalent.

In one embodiment, a plurality of bonding structures may be connected through a linker to form a polymer. In one embodiment, the linker comprises a divalent metal. In another embodiment, the linker comprises a metal carbonate wherein the metal is a divalent metal. In one embodiment, the polymer may comprise a plurality of metal carbonate moieties between bonding structures.

In one embodiment, the polymer may be branched at the bonding structure by connecting it to a plurality of linkers.

In one embodiment, the bonding structure comprises Si—O—Al and Si—O—Si bonds.

Hardening 305, i.e. polycondensation reactions creating polymer structure, of the mixture is allowed to proceed in the mould for a desired period of time. Typically, the mixture continues to harden for a long time. However, in one embodiment, the mixture or article moulded in the mould may be removed from the mould such that the hardening of the mixture continues after said removal from the mould. The method according to the current disclosure may provide quick hardening of the mixture to its final strength. For example, it has been observed that in one embodiment the final compression strength may be achieved in about 24 hours, which is ⅓-½ of time required for hardening of Portland cement. Still the compression strength is high, about 40-50 MPa. Even compression strength as high as 80 MPa has been reached in cases where the mixture is devoid of iron Fe.

In at least some cases, the article moulded in the mould needs to be processed further in order to create the desired element or body part thereof. This may comprise e.g. removing and/or adding material, and/or adding components or elements in the article.

The invention is not limited solely to the embodiments described above, but instead many variations are possible within the scope of the inventive concept defined by the claims below. Within the scope of the inventive concept the attributes of different embodiments and applications can be used in conjunction with or replace the attributes of another embodiment or application.

The drawings and the related description are only intended to illustrate the idea of the invention. The invention may vary in detail within the scope of the inventive idea defined in the following claims.

### REFERENCE SYMBOLS

1 elevator element
2 body part
3 filler-bit
4 weight assembly
5 weight frame
6 elevator pit
7 elevator car
8 roping
9 holder (rack)
100 elevator
300 providing material
301 adding water
302 filling mould
303 adding alkalic reactance
304 adding filler material
305 hardening

1. An elevator element manufacturing method, comprising the steps of:
providing material comprising aluminium silicate precursor and/or calcium silicate precursor in powder and/or granulate form,
filling a mould with a mixture comprising said material, alkalic reactance, and water for creating a mixture, mixture; and
allowing the mixture to realize a polycondensation reaction in the mould for forming a polymer structure based on polycondensation bonding structures.

2. The method as claimed in claim 1, wherein the alkalic reactance comprises potassium soluble silicate.

3. The method as claimed in claim 1, wherein the alkalic reactance comprises sodium soluble silicate.

4. The method as claimed in claim 1, wherein the precursor material comprises at least one of:
blast furnace slag (BF slag),
basic-oxygen furnace slag (BOF slag),
electric-arc furnace slag (EAF slag),
klockner oxygen blown maxhutte slag (KOBM slag), and
casting slag.

5. The method as claimed in claim 1, wherein the precursor material comprises rock-based geopolymer cement.

6. The method as claimed in claim 1, wherein the precursor material comprises fly ash-based geopolymer cement.

7. The method as claimed in claim 1, wherein the precursor material comprises ferro-sialate-based geopolymer cement.

8. The method as claimed in claim 1, further comprising the step of adding Portland cement to the material.

9. The method as claimed in claim 1, further comprising the step of adding a filler material in the mixture for increasing density of the elevator element.

10. The method as claimed in claim 10, wherein the filler material comprises metal-based granulates.

11. The method as claimed in claim 1, wherein the elevator element is moulded in ambient pressure.

12. The method as claimed in claim 1, wherein the elevator element is compression moulded.

13. An elevator element comprising a body part manufactured by the method as claimed in claim 1.

14. The elevator element as claimed in claim 13, being a filler-bit of a counterweight.

15. The elevator element as claimed in claim 13, being a filler-bit of a balance weight.

16. The elevator element as claimed in claim 13, being a car ballast arranged in an elevator car.

17. An elevator comprising:
an elevator shaft;
an elevator car arranged in the elevator shaft; and
an elevator element manufactured by the method claimed claim 1.

18. The method as claimed in claim 2, wherein the alkalic reactance comprises sodium soluble silicate.

19. The method as claimed in claim 2, wherein the precursor material comprises at least one of:
blast furnace slag (BF slag),
basic-oxygen furnace slag (BOF slag),
electric-arc furnace slag (EAF slag),
klockner oxygen blown maxhutte slag (KOBM slag), and
casting slag.

20. The method as claimed in claim 3, wherein the precursor material comprises at least one of:
blast furnace slag (BF slag),
basic-oxygen furnace slag (BOF slag),
electric-arc furnace slag (EAF slag),
klockner oxygen blown maxhutte slag (KOBM slag), and
casting slag.
